(19) United States
(12) Patent Application Publication
(10) Pub. No.: US 2026/0046175 A1
(43) Pub. Date: Feb. 12, 2026

(54) HIGH SPEED TRANSCEIVER AND DIGITAL SIGNAL PROCESSING UNIT

(71) Applicant: NATIONAL YANG MING CHIAO TUNG UNIVERSITY, Hsinchu City (TW)

(72) Inventors: You-Cheng TU, Hsinchu City (TW); Wei-Zen CHEN, Hsinchu City (TW); Rui-Yong KUO, Hsinchu City (TW)

(21) Appl. No.: 19/085,627

(22) Filed: Mar. 20, 2025

(30) Foreign Application Priority Data
Aug. 9, 2024 (TW) 113129991

(51) Int. Cl. H04L 25/03; H04B 17/309

(52) U.S. Cl. CPC H04L 25/03057; H04B 17/346

(57) ABSTRACT

A high speed transceiver includes an analog front-end circuit, a feed-forward equalizer, a decision feedback equalizer, an SNR estimation circuit, and a channel measurement circuit. The analog front-end circuit preprocesses the received signal from the channel, which is then transmitted to the feed-forward equalizer for equalization. The decision feedback equalizer processes the output of the feed-forward equalizer to mitigate post-cursor inter-symbol interference. The channel measurement circuit uses signals from the analog front-end circuit and decision feedback equalizer to extract the single pulse response. The SNR estimator evaluates the receiver noise performance based on the difference between the output and input of the decision feedback equalizer. The output from the channel measurement circuit is used to optimize the settings of the equalizers. The ratio between the signal and the residual inter-symbol interference is used for resource allocation at the receiver for power optimization while maintaining the target bit error rate.

### BACKGROUND

### Field of Disclosure

The present disclosure relates to a high speed transceiver circuit and, more particularly, to the application of serial transmission transceivers.

### Description of Related Art

With the development of science and technology, the demand for network bandwidth continues to increase. Under high speed transmission, as being affected by channel skin effect, dielectric loss, signal reflection from discontinuous contacts, etc., these channel loss effects will cause problems, such as serious inter-symbol interference (ISI) and distortion in the receiving end signal, which in turn increases the bit error rate at the receiving end. Under the high speed and high channel loss transmission conditions, the signal distortion problem caused by inter-symbol interference is difficult to be effectively compensated by the known analog equalizers. Therefore, high speed transceivers based on digital signal processors (DSP) have become a future trend.

However, high speed receivers based on digital signal processors are relatively complicated and have a variety of equalizers inside, such as continuous time linear equalizers, feed-forward equalizers at the transmitter and the receiver, and decision feedback equalizer, etc., and thus there is still a problem that needs to be solved for coordinating the operation of various equalizers in a systematic manner to achieve optimal settings and resource allocation and further improve the overall performance of the receiver.

Therefore, it is desired to provide an improved high speed transceiver architecture, which is combined with a digital signal processing unit to optimize system settings so as to alleviate and/or obviate the aforementioned problems.

### SUMMARY

An object of the present disclosure is to provide a high speed transceiver for receiving a transmitting end signal, which comprises: an analog front-end circuit set, including an analog-to-digital converter, wherein the transmitting end signal passes through the analog front-end circuit set to form a first digital signal; a feed-forward equalizer electrically connected to the analog front-end circuit set; a decision feedback equalizer electrically connected to the feed-forward equalizer, wherein the first digital signal passes through the feed-forward equalizer and the decision feedback equalizer to form a second digital signal; a channel measurement circuit electrically connected to the front-end circuit set and the decision feedback equalizer, and configured to obtain channel feature information of a signal transmission channel based on the first digital signal and the second digital signal; a signal to noise ratio estimation unit electrically connected to the decision feedback equalizer, and configured to obtain a signal to noise ratio of the transmitting end signal at a receiving end based on the output of the decision feedback equalizer, which forms a third digital signal; and a resource allocation control unit electrically connected to the signal to noise ratio estimation unit, and configured to obtain signal to noise ratio information based on the output of the signal to noise ratio estimation unit to form a ninth digital signal so as to adjust a resolution of the analog-to-digital converter and adjust a tap number of the feed-forward equalizer, or a tap number of the decision feedback equalizer, or a tap number of the feed-forward equalizer and the decision feedback equalizer.

Another object of the present disclosure is to provide a digital signal processing unit with full-background calibration for a high speed transceiver, wherein the high speed transceiver is used to receive a transmitting end signal and includes an analog front-end circuit set, and the transmitting end signal passes through the analog front-end circuit set to form a first digital signal, wherein the digital signal processing unit, which comprises: a feed-forward equalizer electrically connected to the analog front-end circuit set; a decision feedback equalizer electrically connected to the feed-forward equalizer, wherein the first digital signal passes through the feed-forward equalizer and the decision feedback equalizer to form a second digital signal; a channel measurement circuit electrically connected to the front-end circuit set and the decision feedback equalizer, and is configured to obtain overall channel feature information of a signal transmission channel and the analog front-end circuit set based on the first digital signal and the second digital signal; a signal to noise ratio estimation unit electrically connected to the decision feedback equalizer, and configured to obtain the signal to noise ratio at a receiving end based on a third digital signal; and a resource allocation control unit electrically connected to the signal to noise ratio estimation unit, and configured to obtain signal to noise ratio information based on a ninth digital signal so as to adjust a resolution of an analog-to-digital converter and a tap number of the feed-forward equalizer and the decision feedback equalizer thereby performing adaptive adaptation on the high speed transceiver.

Other novel features of the disclosure will become more apparent from the following detailed description when taken in conjunction with the accompanying drawings.

### BRIEF DESCRIPTION OF DRAWINGS

FIG. 1 is a schematic diagram illustrating the architecture of a high speed transceiver according to an embodiment of the present disclosure;

FIG. 2 is a schematic diagram illustrating the architecture of a digital signal processing unit and a channel measurement circuit according to an embodiment of the present disclosure;

FIG. 3 is a flow chart illustrating the steps for measuring floating cursors by a channel measurement circuit according to an embodiment of the present disclosure;

FIGS. 4A and 4B are a flow chart of the continuous time linear equalizer adjustment steps according to an embodiment of the present disclosure;

FIG. 5 is a simulation diagram illustrating the floating cursor of the channel measurement circuit according to an embodiment of the present disclosure;

FIG. 6A is a schematic diagram illustrating the transient response results of continuous time linear equalizer calibration using channel measurement circuit parameters according to an embodiment of the present disclosure;

FIG. 6B is a schematic diagram illustrating the SIR results obtained by the signal to inter-symbol interference residual ratio calculation unit according to the channel measurement circuit and the SIR results of the single pulse response of the actual channel plus the continuous time linear equalizer according to an embodiment of the present disclosure;

FIG. 7 is a simulation diagram of the bit error rate versus the measurement error of the channel measurement circuit according to an embodiment of the present disclosure;

FIG. 8 is a schematic diagram illustrating the architecture of a signal to noise ratio estimation unit according to an embodiment of the present disclosure;

FIG. 9 is a schematic diagram illustrating the adaptation of Gaussian noise standard deviation according to an embodiment of the present disclosure;

FIG. 10A and FIG. 10B are schematic diagrams illustrating the comparison between the sampling values inferred from level adaptation and standard deviation adaptation and the actual sampling values according to an embodiment of the present disclosure;

FIG. 11 is a schematic diagram illustrating the probability density function formed by the PAM-4 receiver signal and Gaussian noise according to an embodiment of the present disclosure;

FIG. 12 is a flow chart illustrating the adjustment steps of the resource allocation control unit according to an embodiment of the present disclosure;

FIG. 13 is a simulation diagram illustrating the output of the signal to noise ratio estimation unit according to an embodiment of the present disclosure;

FIG. 14 is a simulation diagram illustrating resolution adjustment of the analog-to-digital converter of the resource allocation control unit according to an embodiment of the present disclosure;

FIG. 15 is a simulation diagram illustrating adjustment of the feed-forward equalizer of the resource allocation control unit according to an embodiment of the present disclosure; and

FIG. 16 is a statistical table of simulation results for different channel losses by the signal to noise ratio estimation unit and the resource allocation control unit according to an embodiment of the present disclosure.

### DETAILED DESCRIPTION OF EMBODIMENT

The implementation of the present disclosure is illustrated by specific embodiments to enable persons skilled in the art to easily understand the other advantages and effects of the present disclosure by referring to the disclosure contained therein. The present disclosure is implemented or applied by other different, specific embodiments. Various modifications and changes can be made in accordance with different viewpoints and applications to details disclosed herein without departing from the spirit of the present disclosure.

It should be noted that in this article, unless otherwise specified, “a” component is not limited to a single component, but may also refer to one or more components.

The ordinals recited herein such as “first”, “second” and so on are intended only to describe the elements claimed and imply or represent neither that the claimed elements have any preceding ordinals, nor that sequence between one claimed element and another claimed element or between steps of a manufacturing method. The use of these ordinals is merely to differentiate one claimed element having a certain designation from another claimed element having the same designation.

In addition, the word “adjacent” in the specification and claims, for example, is used to describe proximity to each other, and does not necessarily mean that they are in contact with each other.

In addition, the description of “when . . . ” or “while . . . ” in the present disclosure means “now, before, or after”, etc., and is not limited to occurrence at the same time. In the present disclosure, the similar description of “disposed on” or the like refers to the corresponding positional relationship between the two elements, and does not limit whether there is contact between the two elements, unless specifically limited. Furthermore, when the present disclosure recites multiple effects, if the word “or” is used between the effects, it means that the effects may exist independently, but it does not exclude that multiple effects may exist at the same time.

In addition, the terms “connect” or “couple” in the description and claims not only refer to direct connection with another component, but also refer to indirect connection or electrical connection with another component. In addition, electrical connection includes direct connection, indirect connection, or communication between two components by radio signals.

In addition, in the specification and claims, the terms “almost”, “about”, “approximately” or “substantially” usually means within 10%, 5%, 3%, 2%, 1% or 0.5% of a given value or range. The quantity given here is an approximate quantity; that is, without specifying “almost”, “about”, “approximately” or “substantially”, it can still imply the meaning of “almost”, “about”, “approximately” or “substantially”. In addition, the term “range of the first value to the second value” or “range between the first value and the second value” indicates that the range includes the first value, the second value, and other values in between.

In addition, each component may be implemented as a single circuit or an integrated circuit in a suitable manner, and may include one or more active components, such as transistors or logic gates, or one or more passive components, for example, resistors, capacitors, or inductors, but not limited thereto. The components may be connected to each other in a suitable manner, for example, respectively matching the input signal and the output signal, and using one or more lines to form a series connection or a parallel connection. In addition, each component may allow input and output signals to enter and exit sequentially or in parallel. The aforementioned configurations are determined according to the actual application.

In addition, in the preset disclosure, terms such as “system”, “apparatus”, “device”, “module”, or “unit” may refer to an electronic component or a digital circuit composed of multiple electronic components, an analog circuit, or other circuits in a broader sense, and unless otherwise specified, they do not necessarily have a hierarchical relationship.

In addition, the technical features of different embodiments disclosed in the present disclosure may be combined to form another embodiment.

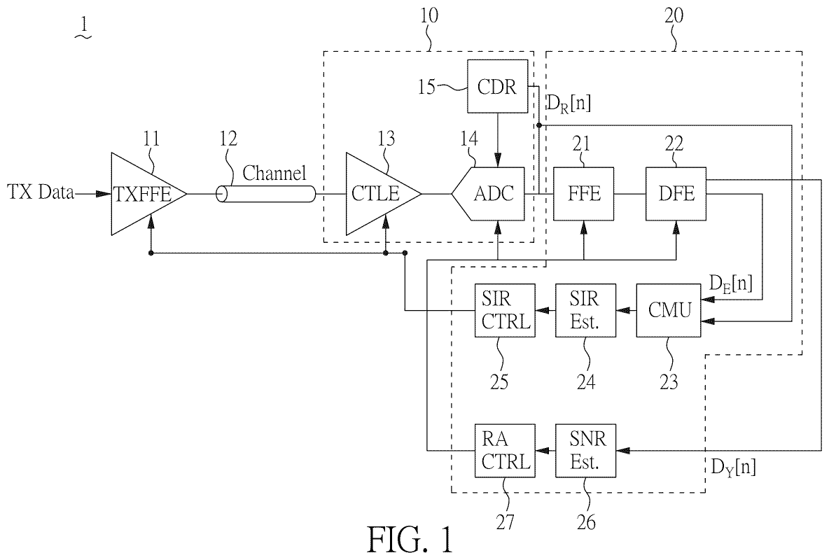

FIG. 1 is a schematic diagram illustrating the architecture of a high speed transceiver 1 according to an embodiment of the present disclosure. As shown in FIG. 1, the receiver in high speed transceiver 1 may include an analog front-end circuit 10 and a digital signal processing unit 20. The analog front-end circuit 10 may be used to receive the signal derived from TX Data passing through a TX feed-forward equalizer (TX FFE) 11 and a signal transmission channel 12 and convert the same into a first digital signal D_{R}[n]. The digital signal processing unit 20 may be used to convert the first digital signal D_{R}[n] into a second digital signal D_{E}[n] and a third digital signal D_{Y}[n], so as to equalize and demodulate the first digital signal D_{R}[n].

In one embodiment of a receiver, the front-end circuit set 10 may include a continuous time linear equalizer (CTLE) 13, an analog-to-digital converter (ADC) 14 and a clock data recovery (CDR) 15. The continuous time linear equalizer 13 receives the input signal. The analog-to-digital converter 14 is electrically connected to the continuous time linear equalizer 13 and the clock data recovery 15. In one embodiment, the transmitting end is combined with the feed-forward equalizer 11 to output data TX Data. The signal is transmitted to the continuous time linear equalizer 13 via the signal transmission channel 12. The continuous time linear equalizer 13 may be used to compensate part of the channel loss of the received signal. The output result may be quantized into a first digital signal D_{R}[n] by the analog-to-digital converter 14.

It should be noted that, under transmission conditions with high channel loss, the feed-forward equalizer at the transmitting end and continuous time linear equalizer at the receiver end only partially compensate for the channel loss, and thus the digital signal process unit (DSP) has to perform further equalization processing on the quantized signal D_{R}[n] at the receiving end. In addition, it should be noted that the range of the signal transmission channel 12 in FIG. 1 is only illustrative, and it is not limited to the transmission path between the transmitting end feed-forward equalizer 11 and the continuous time linear equalizer 13. It may also represent more or less transmission paths, for example, the signal transmission path of the entire high speed transceiver 1, while it is not limited thereto.

Regarding the implementation of the digital signal processing unit 20, in one embodiment, the digital signal processing unit 20 may include a feed-forward equalizer (FFE) 21, a decision feedback equalizer (DFE) 22, a channel measurement circuit 23, a signal to inter-symbol interference residual ratio calculation unit 24, an inter-symbol interference control unit 25, a signal to noise ratio (SNR) estimation unit 26 and a resource allocation control unit 27. The feed-forward equalizer 21 may be electrically connected to the analog-to-digital converter 14 of the analog front-end circuit 10. The decision feedback equalizer 22 may be electrically connected to the feed-forward equalizer 21. The channel measurement circuit 23 may be electrically connected to the decision feedback equalizer 22 or the feed-forward equalizer 21. The signal to inter-symbol interference residual ratio calculation unit 24 may be electrically connected to the channel measurement circuit 23, and the inter-symbol interference control unit 25 may be electrically connected to the signal to inter-symbol interference residual ratio calculation unit 24. The signal to noise ratio estimation unit 26 may be electrically connected to the decision feedback equalizer 22 or the feed-forward equalizer 21, and the resource allocation control unit 27 may be electrically connected to the signal to noise ratio estimation unit 26.

In one embodiment, the feed-forward equalizer 21 is used to receive the first digital signal D_{R}[n] and perform signal compensation on part of the first digital signal D_{R}[n]. The decision feedback equalizer 22 is used to receive the first digital signal D_{R}[n] that passes through the feed-forward equalizer 21 and perform post-cursor signal compensation on the first digital signal D_{R}[n], wherein the first digital signal D_{R}[n] may form the second digital signal D_{E}[n] and the third digital signal D_{Y}[n] after passing through the feed-forward equalizer 21 and the decision feedback equalizer 22, and wherein the second digital signal D_{E}[n] is the output signal produced after the decision feedback equalizer 22 compensates and demodulates signal, and the third digital signal D_{Y}[n] is the output signal produced after the decision feedback equalizer 22 compensates signal without demodulating. The channel measurement circuit 23 may obtain the channel response feature information of the transmitting end equalizer 11, the signal transmission channel 12 and the analog front-end circuit (such as CTLE 13 and ADC 14) based on the first digital signal D_{R}[n] and the second digital signal D_{E}[n]. In one embodiment, the function of the channel measurement circuit 23 may be realized by using adaptive filter technology, but it is not limited thereto. In one embodiment, the channel measurement circuit 23 may calculate the overall channel response feature the transmitting end equalizer 11, the transmission channel 12 and the analog front-end circuit (CTLE13 and ADC14) based on the first digital signal D_{R}[n] and the second digital signal D_{E}[n]. The signal to inter-symbol interference residual ratio calculation unit 24 may estimate the quality of the first digital signal D_{R}[n] based on the output result of the channel measurement circuit 23, and the inter-symbol interference control unit 25 accordingly adjusts the parameter settings of the transmitting end feed-forward equalizer 11 and the continuous time linear equalizer 13. The signal to noise ratio estimation unit 26 may calculate the overall noise feature of the transmitting end equalizer 11, the transmission channel 12, the analog front-end circuit (CTLE 13 and ADC 14) and the amplification effect of the feed-forward digital equalizer 21 based on the third digital signal D_{Y}[n] so as to estimate the quality of the overall noise at the receiver output, and the resource allocation control unit 27 may adjust the parameter settings of the analog-to-digital converter 14, the feed-forward equalizer 21 and the decision feedback equalizer 22 accordingly. As a result, the resource allocation and the inter-symbol interference control of the high speed transceiver 1 can be performed to achieve performance optimization, while it is not limited thereto.

Under ideal circumstances, the second digital signal D_{E}[n] may be regarded as the original transmitting end signal state (TX Data) without inter-symbol interference generated after the first digital signal D_{R}[n] is compensated by the equalizer. Therefore, the channel measurement circuit 23 may use the adaptive operation to obtain the overall single pulse response feature information of the transmitting end equalizer 11, the transmission channel 12 and the analog front-end circuit 10. With the adaptive operation, the output result of the second digital signal D_{E}[n] passing through the finite impulse response filter (FIR filter) is close to the first digital signal D_{R}[n]. Thus, the coefficients of the finite impulse response filter may be expressed as the single pulse response feature of the entire serial connection of the transmitting end equalizer 11, the transmission channel 12 and the analog front-end circuit 10 (CTLE13 and ADC14). It should be noted that, although the second digital signal D_{E}[n] may still be different from the original transmitting end signal TX Data in having some losses, the accuracy of the coefficients of the finite impulse response filter is not critical for the requirements of BER, as long as BER<1e-2, high accuracy can be achieved, thereby providing reliable channel feature information. Another portion that should be noted is that one of the advantages of using adaptive operation is that it is not necessary to use the coefficients of the feed-forward equalizer 21 to perform relatively complicated inverse matrix operations. Instead, a simple architecture may be used for implementation and, even if the coefficients of the equalizer 21 are incorrect, for example, if the compensation is incomplete, it will not cause channel feature measurement errors. In one embodiment, the channel feature may be described by single pulse response. For example, a pulse signal is injected at the input end of the channel, and the pulse signal at the output end is compared with the pulse signal at the input end to obtain the feature of the channel, while it is not limited thereto.

Next, the signal to inter-symbol interference residual ratio calculation unit 24 will be described. In one embodiment, the signal to inter-symbol interference residual ratio calculation unit 24 may be electrically connected to the channel measurement circuit 23, and performs signal to noise ratio calculation based on the output result of the channel measurement circuit 23. The signal to inter-symbol interference residual ratio calculation unit 24 may be implemented by a processor executing software or firmware, or may be implemented in hardware, while it is not limited thereto.

Since the channel feature information obtained by the channel measurement circuit 23 includes the influence of the transmitting end, receiving end, front-end circuit and channel response, the output information of the channel measurement circuit may be regarded as the residual value of inter-symbol interference after the signal passes through the transmitting end feed-forward equalizer 11 and the continuous time linear equalizer 13 and is compensated, which is used as the basis for parameter adjustment of these equalizers.

Next, the inter-symbol interference control unit 25 will be described. In one embodiment, the inter-symbol interference control unit 25 may be electrically connected to the signal to inter-symbol interference residual ratio calculation unit 24, and electrically connected to one of the transmitter feed-forward equalizer 11, the continuous time linear equalizer 13, or electrically connected to all the above components. The inter-symbol interference control unit 25 may be used to receive the inter-symbol interference feature information calculated by the signal to inter-symbol interference residual ratio calculation unit 24, and adjust the parameter setting of the transmitting end equalizer 11 or the continuous time linear equalizer 13, accordingly. In one embodiment, the inter-symbol interference control unit 25 may be implemented by a processor executing software or firmware, or may also be implemented in hardware, while it is not limited thereto.

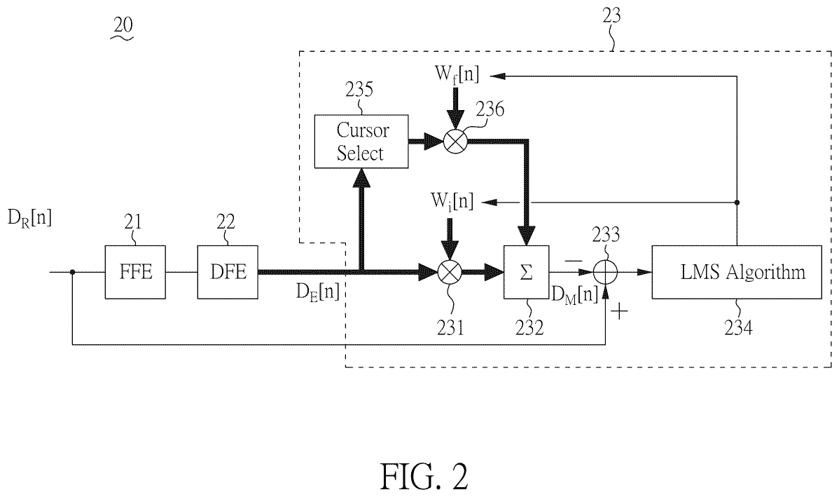

Next, the details of the channel measurement circuit 23 in the digital signal processing unit 20 will be described. FIG. 2 is a schematic diagram illustrating the detailed architecture of the digital signal processing unit 20 according to an embodiment of the present disclosure, and please refer to FIG. 1 at the same time.

As shown in FIG. 2, the channel measurement circuit 23 may include a first multiplier 231, an adder 232, a subtractor 233 and an LMS algorithm executor 234. The first multiplier 231 may be electrically connected to the decision feedback equalizer 22, and the first multiplier 231 may also be electrically connected to the LMS algorithm executor 234, so that the first multiplier 231 may perform multiplication on the data from the decision feedback equalizer 22 and the data from the algorithm executor 234. The adder 232 may be electrically connected to the first multiplier 231, and performs summing operation on the data from the first multiplier 231. The subtractor 233 may be electrically connected to the adder 232 and the analog front-end circuit 10, and calculate the difference between D_{R}[n] and the output data of the adder. The LMS algorithm executor 234 may be electrically connected to the subtractor 233 to receive the output result from the subtractor 233, and the LMS algorithm executor 234 may perform an adaptive algorithm to continuously adjust the adaptation coefficient of the channel measurement circuit 23 (adaptive filter). The adjusted adaptation coefficient of the channel measurement circuit 23 may be fed back to the first multipliers 231 and 236 for the next operation.

In one embodiment, the first multiplier 231 performs multiplication on the second digital signal D_{M}[n] from the decision feedback equalizer 22 and the adaptation coefficient of the channel measurement circuit 23 provided by the algorithm executor 234, which is then accumulated to form a fourth digital signal D_{M}[n]. The channel measurement circuit 23 may continuously provide the corrected adaptation coefficient of the channel measurement circuit 23 so that the fourth digital signal D_{M}[n] may gradually approach the first digital signal D_{R}[n]. The subtractor 233 may serve as a comparator to compare the fourth digital signal D_{M}[n] after summing by the adder 232 (for example, summing the values of different sampling points) with the first digital signal D_{R}[n]. When the comparison result is close to or equal to zero, it represents that the fourth digital signal D_{M}[n] has approached the first digital signal D_{R}[n]; that is, the operation of the channel measurement circuit 23 has reached or approached adaptation. At this moment, the LMS algorithm executor 234 may use the current adaptation coefficient as channel feature information for being provided to the signal to inter-symbol interference residual ratio calculation unit 24.

In one embodiment, for the high speed transceiver 1 of the present disclosure, the received analog signal will be influenced when passing through the transmitting end feed-forward equalizer 11, the signal transmission channel 12 and the front-end circuit set 10, and the actual influence (actual channel feature) may be presented through a single pulse response, wherein the results of the actual influence (actual channel feature) corresponding to the single pulse response may be sampled at a time interval, and the sampling results may be expressed as hᵢ={ . . . h₋₂, h₋₁, h₀, h₁, h₂, . . . }(and so on), where i is an integer, h₀ is the main response cursor of the actual channel feature (such as the cursor when the signal value is maximum), i being larger than zero represents the post-cursor of the actual channel feature, i being smaller than zero represents the pre-cursor of the actual channel feature.

Furthermore, when passing through the transmitting end feed-forward equalizer 11, the signal transmission channel 12 and the front-end circuit set 10, the received analog signal will be influenced by the non-ideal effects of the channel and the circuit to generate inter-symbol interference, thereby forming the first digital signal D_{R}[n]. In one embodiment, if TX Data is represented by D[n], the first digital signal D_{R}[n] may be represented by TX Data(D[n]) and the corresponding impulse response as: D_{R}[n]= . . . +h₋₂D[n+2]+h₋₁D[n+1]+h₀D[n]+h₁D[n−1]+h₂D[n−2]+ . . . (and so on).

In one embodiment, through the operation of the feed-forward equalizer 21 and the decision feedback equalizer 22, the first digital signal D_{R}[n] may form the second digital signal D_{E}[n]. Under ideal circumstances, by using the feed-forward equalizer 21 and the decision feedback equalizer 22 to compensate and demodulate the first digital signal D_{R}[n], the second digital signal D_{E}[n] may approximate the original data D[n] of the received signal. Therefore, the channel measurement circuit 23 may be further used to perform the inverse operation of D_{E}[n] to D_{R}[n] to obtain a value close to the coefficient hᵢ. The value close to the coefficient hᵢ may be regarded as the channel feature information. In one embodiment, the target output of the channel measurement circuit 23 may be expressed as:

$${D}_{M} [ n ] = … + {W}_{- 2} {D}_{E} [ n + 2 ] + {W}_{- 1} {D}_{E} [ n + 1 ] + {W}_{0} {D}_{E} [ n ] + {W}_{1} {D}_{E} [ n - 1 ] + {W}_{2} {D}_{E} [ n - 2 ] + … = {D}_{R} [ n ] ,$$

wherein Wᵢ={ . . . W₋₂, W₋₁, W₀, W₁, W₂, . . . (and so on)} may be regarded as the adaptation coefficient of the channel measurement circuit 23, where i is an integer, and Wᵢ may approach hᵢ when the adaptive operation adapts.

In one embodiment, the adaptive algorithm executed by the algorithm executor 234 of the channel measurement circuit 23 is implemented using least-mean-square (LMS) error algorithm or other algorithms to continuously adjust the adaptation coefficient of the channel measurement circuit 23, while it is not limited thereto. In one embodiment, through the least-mean-square error algorithm, when Wᵢ forms the final adaptation coefficient, D_{E}[n] is made to approach D_{R}[n] and, at this moment, Wᵢ will be close to hᵢ, so that the channel feature information may be obtained. Since the least-mean-square error algorithm may be implemented through simple hardware, such as a simple processor with software or firmware, it is able to achieve the feature of small area and low power consumption, which is suitable for application in single-chip systems.

As a result, the operation of the channel measurement circuit 23 can be understood.

It should be noted that, in the system architecture of the receiver, signal reflections will sometimes occur due to effects such as channel impedance mismatch, and these reflections will usually appear on the post-cursor. Since these reflections are interference, the system designer intends to find out where the reflections are located (such as the timing position in the signal) and eliminate the same. Since the length of the signal transmission channel 12 may be different, there may be a larger gap in the timing position between the post-cursor related to signal reflection and the main cursor of energy concentration; that is, there is a larger time delay between the timing position of the post-cursor and the timing position of the main cursor. Therefore, the present disclosure makes use of the floating tap to eliminate reflection interference so as to reduce system complexity. In the present disclosure, a new floating cursor search algorithm is also provided to facilitate finding the floating cursor (that is, the position of the reflection interference) in the post-cursor, which may be applied to various receiver applications.

With reference to FIG. 2 again, in one embodiment, the channel measurement circuit 23 may further include a cursor selector 235 and a second multiplier 236. The cursor selector 235 may be electrically connected to the decision feedback equalizer 22. The second multiplier 236 may be electrically connected to the cursor selector 235 and may also be electrically connected to the algorithm executor 234. The cursor selector 235 may be used to receive the second digital signal D_{E}[n] from the decision feedback equalizer 22 and make use of a floating cursor search algorithm to scan multiple floating tap nodes (for example, multiple timing positions of the second digital signal D_{E}[n], also known as floating tap nodes). One of the floating tap nodes may be regarded as the timing position of a predetermined floating cursor, and the equalizer coefficient corresponding to one floating tap node may be used as a predetermined floating cursor coefficient W_{f}. The cursor selector 235 may provide at least one cursor of the second digital signal D_{E}[n] to the second multiplier 236, and the LMS algorithm executor 234 may provide the floating cursor coefficient W_{f} to the second multiplier 236, so that the second multiplier 236 may perform multiplication on the two to form a predetermined floating cursor (such as the reflection amount at the timing position). The multiplication result of the second multiplier 236 may be input to the adder 232, and the adder 232 may perform summing on the multiplication result of the second multiplier 236 and the multiplication result of the first multiplier 231, so that the fourth digital signal D_{M}[n] entering the subtractor 233 has a predetermined floating cursor. Then, the adaptive algorithm is continuously executed through the algorithm executor 234, and the floating cursor coefficient W_{f} provided by the algorithm executor 234 may be continuously adjusted and, at the same time, the cursor selector 235 also continues to execute the floating cursor search algorithm, thereby continuously adjusting the selected cursor. Therefore, when the adaptive algorithm reaches adaptation, it is able to find the one with a larger filter coefficient from the predetermined floating cursors for use as the target floating cursor.

The search method for floating cursors may be based on the condition that the corresponding compensation coefficient value is larger than the predetermined threshold or, after scanning all post-cursors, several cursors with larger corresponding coefficients are selected as the compensation objects of the floating cursors, while it is not limited thereto. As a result, the timing position with larger reflection interference can be found, while it is not limited to this.

In other words, the channel measurement circuit 23 may support a floating cursor, and the cursor selector 235 may scan the second digital signal D_{E}[n] output by the decision feedback equalizer 22 on multiple floating tap nodes, and select one with a larger floating cursor coefficient W_{f} therefrom for use as a floating cursor to perform equalizer post-cursor compensation, while it is not limited thereto.

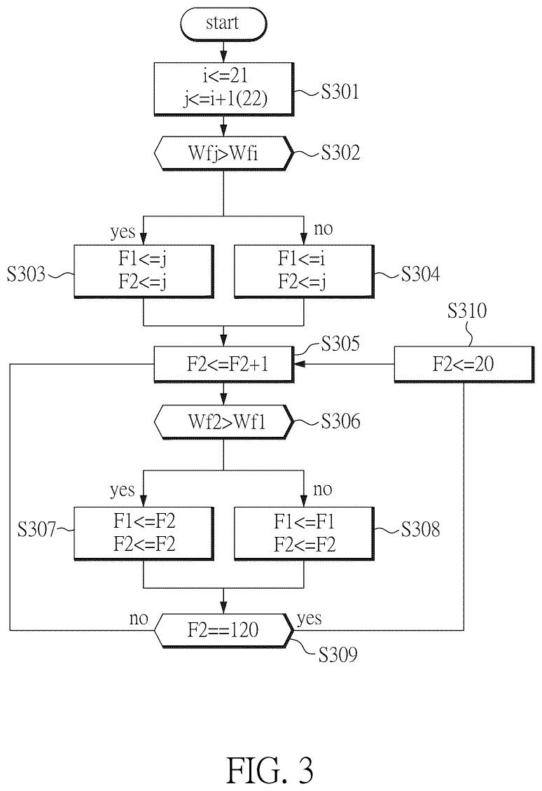

In an example of searching for a floating cursor (also with reference to FIG. 3), in which a channel measurement circuit 23 is exemplified by combining 20 post-cursors plus a floating cursor (W_{f}) with a larger coefficient, and enabling the floating cursor scanning range to be the 21-st to 120-th post-cursor (that is, the scanning range of 100 post-cursors), W_{f1} corresponding to the floating cursor F1 records the floating cursor with the maximum coefficient value, and the floating cursor F2 is a scanning cursor that continuously scans the tap nodes at different timing positions, where W_{f2} corresponding to cursor F2 records the coefficient value of each scan. FIG. 3 is a flow chart illustrating the steps for equalizer adjustment according to an embodiment of the present disclosure, wherein the scanning procedure for the floating cursor is as follows. First, step S301 is executed, in which the cursor selector 235 selects the i-th tap, where i=21; that is, if the multiplier input corresponding to W₀ (corresponding to the main cursor) is D_{E}[n], the cursor selector 235 selects D_{E}[n−i] tap node and the channel measurement circuit 23 performs adaptation operation based on this setting; at this moment, the weight coefficient of the corresponding floating cursor is W_{fi} and, at the same time, the cursor selector 235 selects the j-th tap, where j=i+1; and the channel measurement circuit 23 performs adaptation calculation based on this setting and, at this moment, the weight coefficient of the corresponding floating cursor is W_{fj}. Then step S302 is executed, in which, if W_{fj}>W_{fi}, step S303 is executed to have floating cursor F1=j, floating cursor F2=j, W₁=W_{fj} and W_{f2}=W_{fj}; otherwise, if W_{fj}≤W_{fi}, step S304 is executed to have floating cursor F1=i, floating cursor F2=j, W_{f1}=W_{fi} and W_{f2}=W_{fj}. Then, step S305 is executed, in which the floating cursor F2 scans the post-cursor backward and, making F2<=F2+1, the channel measurement circuit 23 performs adaptation calculation based on this setting. Then, step S306 is executed, in which, if determining W_{f2}>W_{f1}, step S307 is executed to make the floating cursor F1=F2, and keep F2 unchanged; if determining W_{f2}≤W_{f1}, step S308 is executed, in which the floating cursors F1 and F2 remain unchanged. Then, step S309 is executed to determine whether the floating cursor has scanned to the last post-cursor (such as 120) in the scanning range and, if not, step S305 is repeated to cause the floating cursor F2 to continue scanning backward, otherwise, step S310 is executed to cause the floating cursor F2 to restart from the initially selected tap in the scanning range, and step S305 is executed to restart scanning, in which the floating cursor scanning range will continue to be rescanned during the operation of the circuit. The method can also be extended to find multiple floating cursors with larger coefficients.

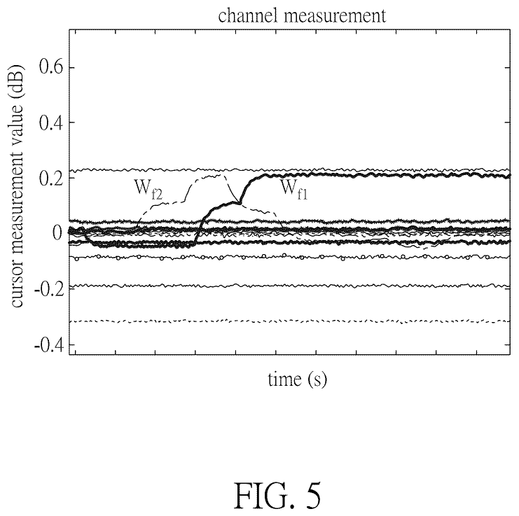

FIG. 5 is a schematic diagram of the transient response of the floating cursor search corresponding to FIG. 3. FIG. 5 shows that W_{f2} continues to scan the corresponding coefficient size of the post-cursor in a given range, so that its value also continues to change, while W_{f1} continues to update to the largest cursor coefficient and its corresponding cursor position when W_{f2} scans.

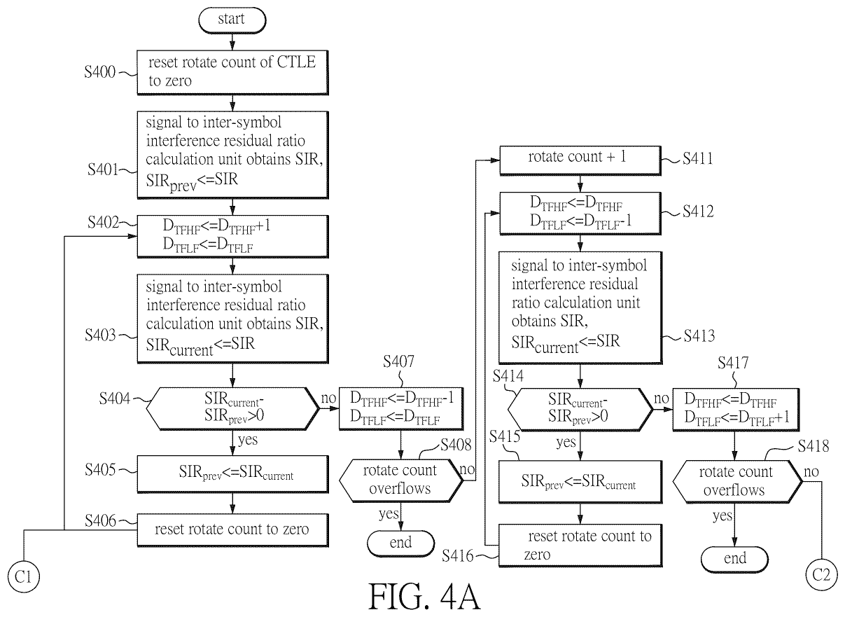

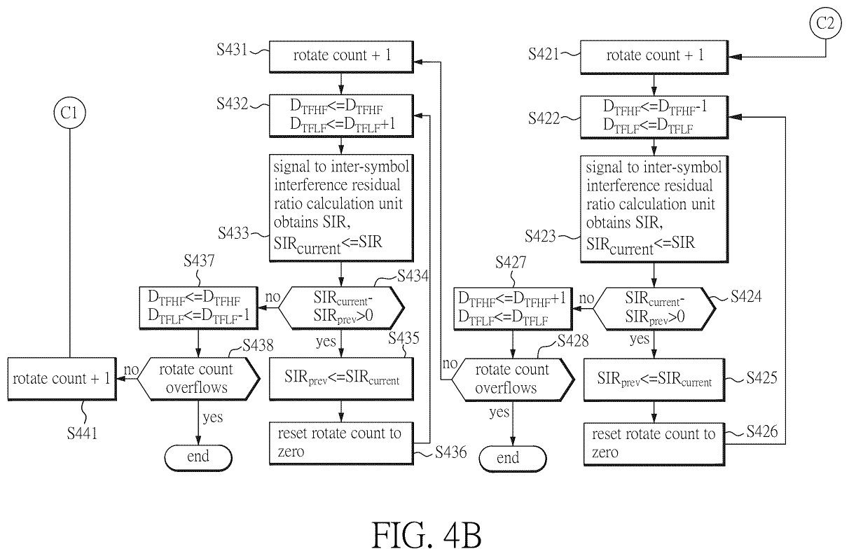

Next, the details of the signal to inter-symbol interference residual ratio calculation unit 24 and the inter-symbol interference control unit 25 will be described, and please refer to FIGS. 4A and 4B. FIGS. 4A and 4B are a flow chart of the equalizer adjustment steps according to an embodiment of the present disclosure, which is used to illustrate the operation details of the signal to inter-symbol interference residual ratio calculation unit 24 and the inter-symbol interference control unit 25, and please also refer to FIG. 1 and FIG. 2. In FIGS. 4A and 4B, an example is given by adjusting the continuous time linear equalizer 13. In the example, the continuous time linear equalizer 13 has multiple gear levels for setting, and different gear levels may correspond to different frequency compensations. The transfer function of the continuous time linear equalizer 13 may be expressed as TF_{CTLE}=TF_{HF}−TF_{LF}, wherein TF_{HF} and TF_{LF} are each a system with two poles and one zero point, the poles ω_{p1,H}, ω_{p2,H} of TF_{HF} are located at the Nyquist frequency, the zero point ω_{z,H} can be adjusted, and the two poles ω_{p1,L}, ω_{p2,L} and one zero point ω_{z,L} of TF_{LF} can be adjusted. The gear level adjustment setting of the continuous time linear equalizer 13 is described as follows. The frequency of the zero point ω_{z,H} is adjusted through a digital control signal D_{TFHF}. If the value of D_{TFHF} is increased, ω_{z,H} will move to the low frequency to increase the difference between the high-frequency gain (Nyquis frequency) and the DC gain of the continuous time linear equalizer 13 and enhance the compensation ability of the continuous time linear equalizer 13, thereby causing the values of the post-cursors (such as h₁, h₂, h₃) that are closer to the main cursor to decrease, and vice versa if D_{TFHF} is decreased. In addition, the frequencies of the poles and zero point of TF_{LF} are adjusted through another digital control signal D_{TFLF}. If D_{TFLF} is increased, ω_{p1,L}, ω_{p2,L} and ω_{z,L} will move to low frequency at the same rate, so that the values of post-cursors (such as h₅, h₆, . . . ) that are far away from the main cursor decrease and, on the contrary, move to high frequency at the same rate. Therefore, the continuous time linear equalizer 13 has two adjustment directions of high frequency and low frequency, which are to increase/decrease the digital control signals D_{TFHF} and D_{TFLF}, respectively.

As shown in FIGS. 4A and 4B, step S400 is first executed, in which the inter-symbol interference control unit 25 resets the gear level adjustment count of the continuous time linear equalizer 13 to zero. Then, step S401 is executed, in which the signal to inter-symbol interference residual ratio calculation unit 24 evaluates the signal to inter-symbol interference residual ratio according to the output result of the channel measurement circuit 23, so that the value obtained by the signal to inter-symbol interference residual ratio calculation unit 24 is SIRₚᵣₑᵥ. Then, step S402 is executed, in which the symbol interference control unit 25 increases the D_{TFHF} gear level (for example, to be D_{TFHF+1}) while maintaining the D_{TFLF} gear level. Then, step S403 is executed, in which the signal to inter-symbol interference residual ratio calculation unit re-evaluates the signal to inter-symbol interference residual ratio based on the output result of the channel measurement circuit 23, so that the value obtained by the signal to inter-symbol interference residual ratio calculation unit 24 is SIR_{current}. Then, step S404 is executed to determine whether SIR_{current} is larger than SIRₚᵣₑᵥ. When SIR_{current}>SIRₚᵣₑᵥ, step S405 is executed to set the value of SIR_{current} to be SIRₚᵣₑᵥ and step S406 is executed next, in which the inter-symbol interference control unit 25 resets the gear level adjustment count (rotate count) of the continuous time linear equalizer 13 to zero, and then step S402 is re-executed. When SIR_{current}≤SIRₚᵣₑᵥ, step S407 is executed, in which, at this moment, the inter-symbol interference control unit 25 will adjust the D_{TFHF} gear level back to the gear levels before this adjustment (that is, decrease the D_{TFHF} gear level while maintaining the D_{TFLF} gear level). Then, step S408 is executed, in which the inter-symbol interference control unit 25 determines whether the gear level adjustment count of the continuous time linear equalizer 13 is smaller than a predetermined value (the predetermined value is, for example, 8, but not limited thereto). When the gear level adjustment count is larger than the predetermined value (overflow), the coefficient adjustment of the continuous time linear equalizer 13 is ended. When the gear level adjustment count is smaller than the predetermined value, step S411 is executed, in which, at this moment, the inter-symbol interference control unit 25 will increase the gear level adjustment count of the continuous time linear equalizer 13 (for example, adding 1 thereto). Then, step S412 is executed, in which the inter-symbol interference control unit 25 maintains the existing D_{TFHF} setting while reducing D_{TFLF}. Then, steps S413 to S414 are executed, and the execution action of which is consistent with steps S403 to S404. When SIR_{current}>SIRₚᵣₑᵥ, steps S415 to S416 are executed, and the execution action thereof is the same as that of step S405 to S406, except that, after S416 is executed, S412 will be executed repeatedly. When SIR_{current}≤SIRₚᵣₑᵥ, step S417 is executed, and the execution action is the same as step S407. Then, step S418 is executed, in which, when the gear level adjustment count is smaller than the predetermined value, step S421 is executed so that the inter-symbol interference control unit 25 increases the gear level adjustment count of the continuous time linear equalizer 13 (for example, adding 1 thereto), otherwise, the coefficient adjustment of the continuous time linear equalizer 13 is ended. Then, step S422 is executed, in which the inter-symbol interference control unit 25 adjusts the continuous time linear equalizer 13 in a direction of maintaining D_{TFLF} and reducing D_{TFHF} at the same time. Then, steps S423 to S424 are executed, and the execution action is consistent with step S403 to S404. When SIR_{current}>SIRₚᵣₑᵥ, steps S425 to S426 are executed, which are the same as steps S405 to S406. After S426 is executed, step S422 will be executed repeatedly. When SIR_{current}≤SIRₚᵣₑᵥ, step S427 is executed, and the execution action is the same as step S407. Then, step S428 is executed, in which, when the gear level adjustment count is smaller than the predetermined value, step S431 is executed to make the inter-symbol interference control unit 25 increase the gear level adjustment count of the continuous time linear equalizer 13 (for example, adding 1 thereto). Next, step S432 is executed, in which the inter-symbol interference control unit 25 changes the adjustment direction of the continuous time linear equalizer 13 to increase D_{TFLF} while maintaining the D_{TFHF} setting. Then, steps S433 to S434 are executed, and the execution action of which is consistent with steps S403 to S404. When SIR_{current}>SIRₚᵣₑᵥ, steps S435 to S436 are executed, which are the same as steps S405 to S406. After S436 is executed, S432 will be executed repeatedly. When SIR_{current}≤SIRₚᵣₑᵥ, step S437 is executed, and the execution action is the same as step S407. Then, step S438 is executed, in which, when the gear level adjustment count is smaller than the predetermined value, step S441 is executed to make the inter-symbol interference control unit 25 increase the gear level adjustment count of the continuous time linear equalizer 13 (for example, adding 1 thereto), and then the process returns to step S402 and, until the gear level adjustment count in any one of the steps of S407, S417, S427 and S437 reaches the predetermined value (overflow), the adaptation of the continuous time linear equalizer 13 is completed.

Regarding steps S403, S413, S423 and S433, the inter-symbol interference residual ratio calculation unit 24 may obtain the inter-symbol interference feature information based on the sum of squares of the channel feature information (for example, Wᵢ). In one embodiment, the overall signal to inter-symbol interference residual ratio of the transmitting end equalizer 11, the transmission channel 12 and the analog front-end circuit (13, 14) may be expressed as: SIR=10 log 10(W₀²/(Σ_{i≠0}ⁱWᵢ²)), wherein the higher the SIR, the better the compensation effect of the continuous time linear equalizer 13 is, and thus the gear level of the continuous time linear equalizer 13 may be adjusted according to the value of SIR. If the SIR after this adjustment is larger than the SIR after the previous adjustment, it indicates that the effect of the current gear level setting of the continuous time linear equalizer 13 is better than the previous setting, so that the current gear level setting may be the best or a better setting, and thus the gear adjustment count may be reset to zero, and steps S402, S412, S422 and S432 may be re-executed, respectively.

Regarding steps S407, S417, S427 and S437, if the SIR after this adjustment is not larger than the SIR after the previous adjustment, and the gear adjustment count has reached the predetermined value, it indicates that the adjacent gear adjustment results are worse than the previous setting, and thus there is a high possibility that the previous gear level setting is the optimal setting, so that the adjustment of the continuous time linear equalizer 13 may be completed. If the SIR after this adjustment is not larger than the SIR after the previous adjustment, and the gear adjustment count has not yet reached the predetermined value, it indicates that the effect of this gear level setting may be worse than the previous setting, and thus there is a high possibility that the adjustment has been made to be close to the optimal value of the gear level of this dimension (high frequency or low frequency), so that the gear level adjustment may be switched to another dimension (high frequency or low frequency) and the gear level of the continuous time linear equalizer 13 is adjusted. For example, step S402 is switched to step S412, step S412 is switch to step S422, step S422 is switched to step S432, step S432 is switched to step S402, and the gear adjustment count is accumulated.

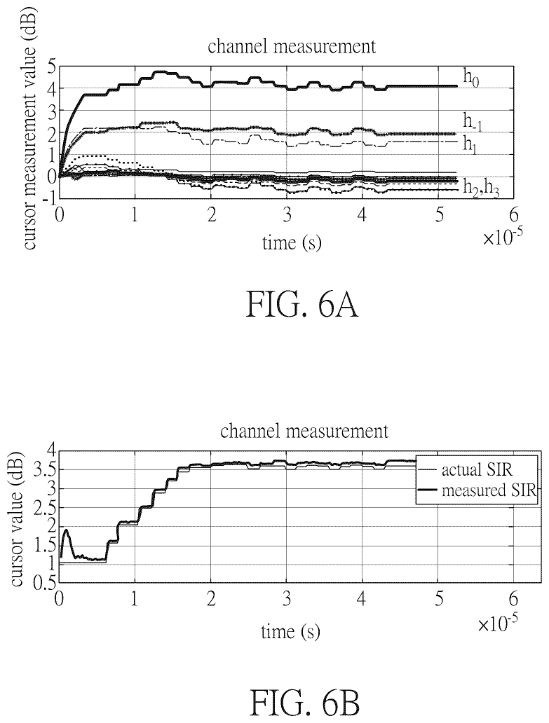

Next, please refer to FIG. 6A and FIG. 6B. FIG. 6A shows the transient response results of continuous time linear equalizer calibration using the parameters of the channel measurement circuit 23. As the setting of the analog continuous time linear equalizer is changed, the single pulse response results of the channel measurement circuit also change. For example, when changing the compensation gain of the high-frequency portion, the cursor of the analog front-end single pulse response that is closer to the main cursor will decrease. FIG. 6B shows the SIR result obtained by the signal to inter-symbol interference residual ratio calculation unit 24 based on the channel measurement circuit 23, and the SIR result of the single pulse response of the actual channel plus the continuous time linear equalizer 13. It can be seen that, the SIR gradually increases at the beginning, tries different update directions in the middle period, and maintains the highest value of SIR in the final.

In one embodiment, the inter-symbol interference residual ratio control unit 25 may perform adaptive adjustment on the continuous time linear equalizer 13, wherein the adaptive adjustment may be implemented using the gradient descent method based on the SIR estimation result (as described above), while it is not limited thereto, so as to find the corresponding setting parameters of the continuous time linear equalizer 13 thereby making the channel measurement circuit have the best SIR value.

Accordingly, the parameter adjustment of the continuous time linear equalizer 13 of the present disclosure can be realized.

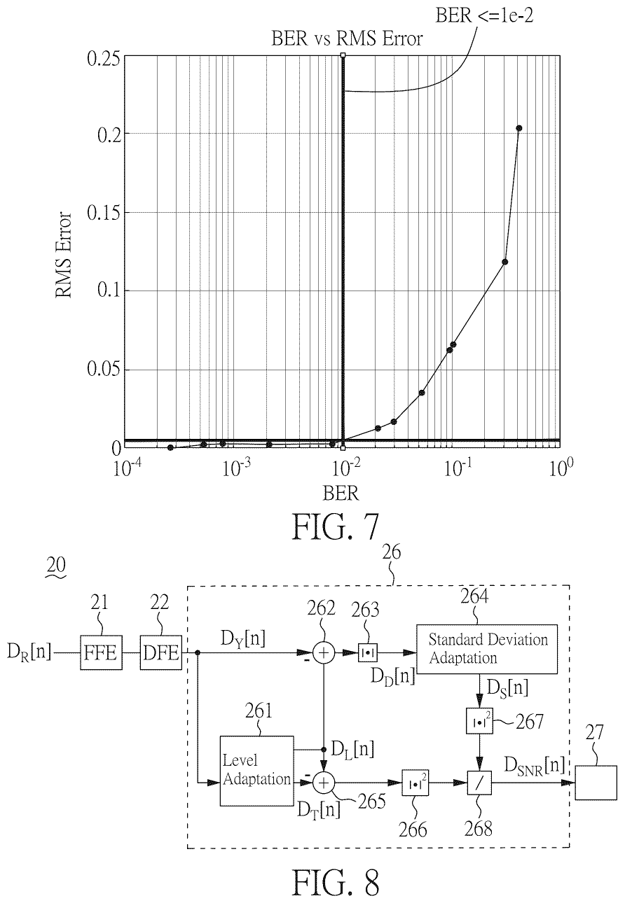

FIG. 7 is a simulation diagram of the bit error rate (BER) versus the measurement error of the channel measurement circuit 23 according to an embodiment of the present disclosure. The bit error rate in the present disclosure may represent the ratio of errors between the second digital signal D_{E}[n] and the transmitting end signal TX Data; that is, it may represent that the pre-equalizer 21 and the decision feedback equalizer 22 have not yet completely compensates for high-frequency loss and inter-symbol interference effects caused by signal passing through the signal transmission channel 12.

As shown in FIG. 7, when the transmission loss has not been fully compensated or over-compensated (for example, when the bit error rate is about 4*10⁻¹), the measurement error of the channel measurement circuit 23 is about 20%. Then, as BER increases (for example, when the bit error rate drops to 10⁻¹), the measurement error of the channel measurement circuit 23 is about 6% and, when the bit error rate is about 10⁻², the measurement error of the channel measurement circuit 23 is about 1%. It can be seen from this that, even when the transmission loss has not been fully compensated, the measurement of channel features in the present disclosure still has a considerable degree of reliability and may be used for flexible configuration of each equalizer, while it is not limited thereto.

The receiver signal to noise ratio estimation unit 26 and the resource allocation control unit 27 provided in the present disclosure will be described in detail in the following description in conjunction with the drawings, so that the novel features of the present disclosure will become clearer.

FIG. 8 is a detailed structural diagram of the signal to noise ratio estimation unit 26 according to an embodiment of the present disclosure, and please refer to other related figures at the same time. In one embodiment, the signal to noise ratio estimation unit 26 may be electrically connected to one of the feed-forward equalizer 21 and the decision feedback equalizer 22 so as to calculate the signal to noise ratio feature information, thereby providing the same to the resource allocation control unit 27. In one embodiment, the signal to noise ratio estimation unit 26 may be implemented by a processor executing software or firmware, or may be implemented in hardware, while it is not limited thereto.

For the high speed transceiver 1, the remaining signal after the inter-symbol interference is completely eliminated by the equalizer will be influenced by various noises, including thermal noise and flicker noise contributed by the internal components of the high speed transceiver 1, or quantization errors generated by digital circuit quantization signals, etc. When these noises are superimposed on the signal of the high speed transceiver 1 at the same time, the probability density function of the total noise contributed thereby may be determined by the central limit theorem (CLT) and will be existed in the form of a Gaussian distribution. Therefore, the signal to noise ratio estimation algorithm provided in the present disclosure is designed based on the premise that the noise on the receiving end signal is in Gaussian distribution.

Taking a receiving system such as PAM-4 as an example, the signal to noise ratio estimation unit 26 may be equipped with a level adaptation unit 261. The level adaptation unit 261 may perform four levels of adaptation on the output of the equalizer using the SSLMS (sign-sign least-mean-square) algorithm to obtain the fifth digital signal D_{L} [n], and to obtain three thresholds of the sixth digital signal D_{T}[n], respectively, by averaging the fifth digital signal D_{L} [n](as shown in FIG. 11). Then the subtractor 265 and the squarer 266 perform a square difference calculation on the fifth digital signal D_{L} [n] and the sixth digital signal D_{T}[n] to obtain the signal power.

In order to estimate the signal to noise ratio, it is also required to have information on noise power. According to the assumption, this noise presents a Gaussian distribution, and the noise power of Gaussian noise is: Noise Power (P_{N})=σₙ², where σₙ is the standard deviation of Gaussian noise, and the noise power is a variation of Gaussian noise. The Gaussian distribution will be distributed outwards with the mean as the center, and the mean here is the fifth digital signal D_{L} [n] that is adapted as described above. Then, the sixth digital signal D_{T}[n] may be used to determine the sign of the equalizer output. For example, if the third digital signal D_{Y}[n] output from the equalizer falls between two thresholds of the sixth digital signal D_{T}[n] that are respectively +2 and 0, the sign may be restored to +1. Under ideal circumstances, if the originally transmitted sign is +1, the third digital signal D_{Y}[n] should be equal to the corresponding fifth digital signal D_{L}[n]. However, the third digital signal D_{Y}[n] is influenced by noise, resulting in that it deviates from the fifth digital signal D_{L} [n]. The given offset distance here is the seventh digital signal D_{D}[n]=abs(D_{Y}[n]−D_{L} [n]), that is, the absolute distance (absolute value of numerical difference) of D_{Y}[n] and D_{L} [n], and the above calculation can be realized through the subtractor 262 and the absolute value device 263.

After having the information contributed by the noise, a specific threshold has to be found to infer back the value of the standard deviation, and this portion may be realized by the standard deviation adaptation unit 264. The following is the process performed by the standard deviation adaptation unit 264. At first, the threshold is set to a constant (for example, zero). Then, the current distance difference is obtained in each operation cycle, that is, the seventh digital signal D_{D}[n] (that is, the offset distance of the third digital signal D_{Y}[n] deviated from the fifth digital signal D_{L}[n]). If the current threshold is larger than the seventh digital signal D_{D}[n], the threshold will be deducted downward by one unit. Conversely, if the current threshold is smaller than the seventh digital signal D_{D}[n], the threshold will be accumulated upward by one unit. After a period of calculation, this threshold will adapt to a level where the downward deduction and upward accumulation probabilities are almost the same, that is, where the probabilities are each 50%. Since the Gaussian distribution is symmetrical to the mean, this threshold may be regarded as being on both sides of the mean, and the probability density function of the Gaussian distribution is divided into 50% of the area inside and outside, wherein this threshold is named as the “50% threshold” as shown in FIG. 9.

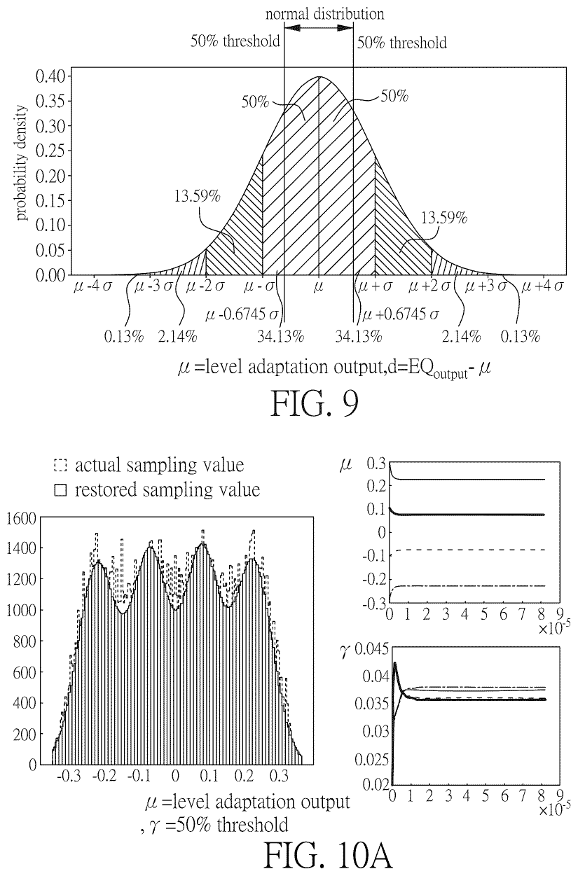

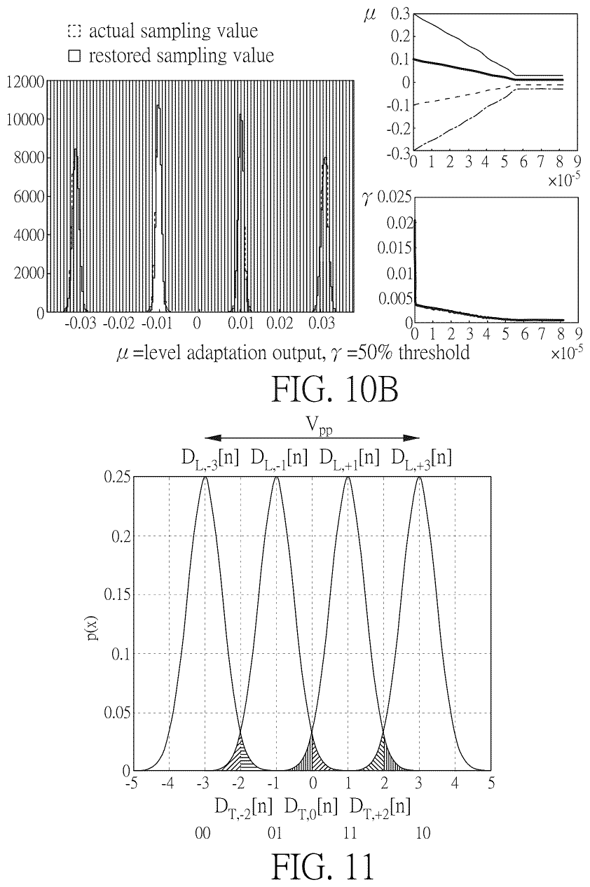

When having the area percentage of the probability density function cut out by any threshold, it is able to infer back the relationship between the threshold and the standard deviation by referring to a lookup table; for example, the 68% threshold is one standard deviation away from the mean, the 95% threshold is two standard deviations from the mean, and so on. After referring to a lookup table, it can be found that the 50% threshold is 0.6745 standard deviations from the mean. Therefore, by dividing the 50% threshold by 0.6745, the standard deviation of the Gaussian noise, which is the eighth digital signal D_{S}[n], may be obtained. Finally, the squarer 267 is used to perform the standard deviation square operation to obtain the noise power. In addition, FIG. 10A and FIG. 10B are simulations when the channel loss is large and the channel loss is small, respectively. The histograms of the solid lines in the left half portions of FIG. 10A and FIG. 10B are the sampling distributions restored using the fifth digital signal D_{L} [n] and the eighth digital signal D_{S}[n] that were adapted as described above, while the histograms of the dotted lines are the actual sampling distribution. In addition, the horizontal axes of the left half portions of the graphs in FIG. 10A and FIG. 10B represent the sampling value, and the vertical axes represent the number of samplings. The horizontal axes of the right half portions of the graphs in FIG. 10A and FIG. 10B represent the simulation time, and the vertical axes represent the adaptation value. As shown in FIG. 10A and FIG. 10B, it can be seen that, whether the channel loss is large or small, a distribution close to the actual situation can be restored, indicating that it is a reasonable assumption that the noise on the signal has a Gaussian distribution, and the adaptation results of the fifth digital signal D_{L} [n] and the eighth digital signal D_{S}[n] are correct.

Next, the resource allocation control unit 27 will be described. In one embodiment, the resource allocation control unit 27 can be electrically connected to the signal to noise ratio estimation unit 26, thereby adjusting the parameter settings or levels of the analog-to-digital converter 14, the feed-forward equalizer 21 and the decision feedback equalizer 22. In one embodiment, the resource allocation control unit 27 may be implemented by a processor executing software or firmware, or may be implemented in hardware, while it is not limited thereto.

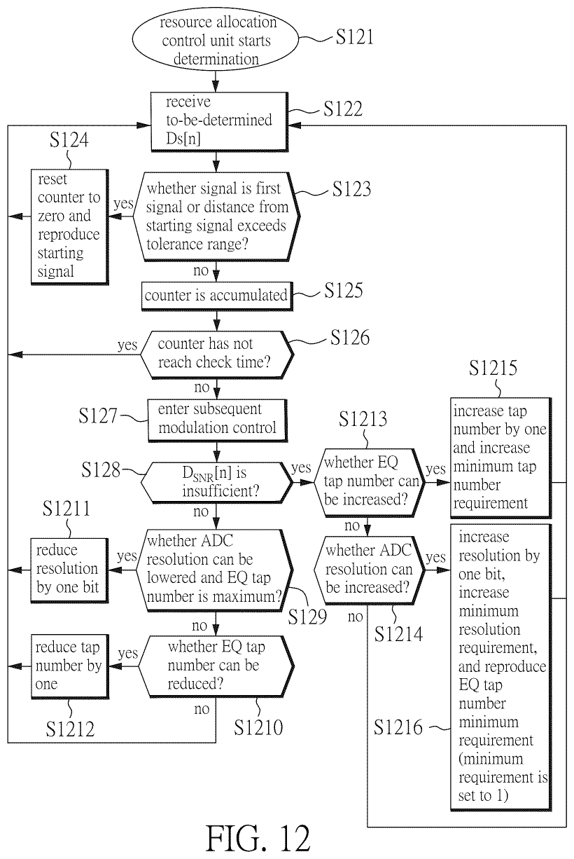

Please refer to FIG. 8 again. When obtaining the signal power and noise power, the divider 268 may divide the two to obtain the signal to noise ratio of the current receiver, that is, the ninth digital signal D_{SNR}[n], and then the resource allocation control unit 27 is used to control the analog-to-digital converter 14 and the equalizers 21, 22. FIG. 12 is a flow chart illustrating adjustment steps performed by the resource allocation control unit 27 according to an embodiment of the present disclosure. It is noted that, in view of FIGS. 10A and 10B, whether it is the fifth digital signal D_{L} [n] or the eighth digital signal D_{S}[n], a period of time is required to adapt so as to reach stability, and the correct value of the eighth digital signal D_{S}[n] may be found after the fifth digital signal D_{L} [n] adapts, so that the adaptation speed will be set slower. At this moment, the resource allocation control unit 27 needs to confirm whether the eighth digital signal D_{S}[n] has adapted completely before the subsequent adjustments. For this purpose it needs to define two variables, that is, tolerance and check time. Generally, observing whether the signal adapts with the naked eyes will be based on whether the signal oscillates within a fixed range for a long time and, based on this principle, when the adjustment performed by the resource allocation control unit 27 enters the adaptation determination steps S121 and S122, if the current eighth digital signal D_{S}[n] is the first piece of data, it is used as the starting point, and the subsequent eighth digital signal D_{S}[n] is subtracted from the starting point and the absolute value thereof is taken. Then, in step S123, it is confirmed whether the distance between the two exceeds the tolerance range. If it is no, in step S125, the counter (for example, the counter inside the resource allocation control unit 27) is accumulated once and the observation continues; if it is yes, in step S124, the counter is reset to zero, and this input is used as the new starting point to re-observe the adaptation. When the counter reaches the same detection number as that previously set, step S126 is entered, indicating that the detection signal has adapted. At this moment, the ninth digital signal D_{SNR}[n] is the correct value, and step S127 is entered to use the current signal to noise ratio estimation value to control subsequent circuits.

Before discussing the subsequent operating principle of the resource allocation control unit 27, it has to first explain the signal to noise ratio requirements of the receiver 1. Usually, when designing the transceiver circuit, a specification will be given for the bit error rate (BER). For example, when the bit error rate is 10⁻⁶, it means that there can be only one error bit or less in one million bits decoded by the receiver. The following description will explain how to find out the relationship between bit error rate and signal to noise ratio.

FIG. 11 shows the probability density function of the PAM-4 signal influenced by Gaussian noise, wherein the level between +3 and −3 is defined as the signal peak-to-peak value (V_{PP}). When the standard deviation of Gaussian noise is not too large, the symbols will enter the judgment interval of adjacent symbols due to the influence of noise, resulting in incorrect output symbols. In order to reduce the number of error bits, data is represented by Gray code for transmitting so that adjacent symbols only differ by one bit.

Under the premise that the noise is in Gaussian distribution, the error rate of a PAM-N signal (P_{e,PAM-N}) may be written as the following formula:

$${P}_{e , PAM - N} = \frac{2 ( N - 1 )}{N} Q ( \frac{{V}_{pp}}{2 ( N - 1 ) {σ}_{n}} ) ,$$

wherein N is the number of PAM modulations, Q(x) is the Q function, and N=4 is applied to have

$$SER = {P}_{e , PAM - 4} = \frac{2 ( 4 - 1 )}{4} Q ( \frac{{V}_{pp}}{2 ( 4 - 1 ) {σ}_{n}} ) = 1.5 Q ( \frac{{V}_{pp}}{6 {σ}_{n}} ) ,$$

where SER is the symbol error rate, which is equivalent to signal error rate. Next, from the deriving of the above, the relationship between signal to noise ratio and symbol error rate may be obtained as:

$$SNR = \frac{{P}_{s}}{{P}_{N}} = \frac{5}{36} \frac{{V}_{pp}^{2}}{{σ}^{2}} = 5 {( \frac{{V}_{pp}}{6 σ} )}^{2} ⇒ SER = 1.5 Q ( \sqrt{\frac{SNR}{5}} ) .$$

When there is a symbol error, only one bit of the two bits has an error, so that the formula may be written as:

$$BER = \frac{1}{2} SER = 0.75 Q ( \sqrt{\frac{SNR}{5}} ) .$$

After calculation, it can be seen that the signal to noise ratio of the receiver signal needs to be larger than 20.42 dB to meet the bit error rate of less than 10⁻⁶. Herein, the minimum signal to noise ratio threshold is set to 21 dB to leave some design margin. As can be seen from FIGS. 10A and 10B, the error interval between +3 and −3 is of only one side, so that in the algorithm of the Gaussian standard deviation adaptation unit 264, the third digital signal D_{Y}[n] that exceeds +3 level and is less than −3 level is not considered to avoid the poor linearity provided by the analog circuit near the maximum swing of the voltage, which will influence the adaptation of +3 and −3 standard deviations.

Please refer to FIG. 12 again. After obtaining the minimum requirement of the signal to noise ratio through the specification of the bit error rate, the process enters step S127 of the subsequent modulation control of the resource allocation control unit 27. Since reducing the resolution of the analog-to-digital converter 14 may reduce the resolution of all subsequent digital signal processing circuits, and the increase or decrease in the tap number of the equalizers 21 and 22 only affects the operations within its own circuit, it is believed that, from the perspective of optimizing the overall circuit power consumption, reducing the resolution of the analog-to-digital converter 14 has a higher priority than reducing the tap number of the equalizers 21 and 22. Therefore, if the signal to noise ratio in step S128 is sufficient, the process will first enter step S1211 to reduce the resolution of the former, and then proceed to step S1212 to reduce the tap number of the latter. Conversely, if the signal to noise ratio in step S128 is insufficient, the process will enter step S1215 to first increase the tap number of the latter and, when the tap number of the latter has increased to the maximum number, the process then enters step S1226 to increase the resolution of the former.

In one embodiment, it uses simulation to obtain the highest resolution of the analog-to-digital converter 14 and the maximum number of the tap number of the equalizers 21 and 22 required in the worst case, which are the default values of the system. On the other hand, the value of the minimum resolution and the minimum tap number requirement will be given for the two, such as a resolution of 3 bits and an equalizer of tap number being 0, which are used as a lower bound for system resource optimization to determine whether the hardware resources can be reduced further or have reached the optimal situation, and this value will also be changed according to the output of the signal to noise ratio estimation unit 26, as shown in steps S1215 and S1216 in FIG. 12.

In one example, the situation where the signal to noise ratio is sufficient is first discussed. If the resolution of the current analog-to-digital converter 14 is higher than the lowest resolution in step S129, step S1211 is entered to reduce the resolution of the analog-to-digital converter 14 by one bit. If the current resolution of the analog-to-digital converter 14 is already the lowest resolution, step S1210 may be entered to determine whether the tap number of the equalizers 21 and 22 can be reduced. The reduction mode of the equalizers 21 and 22 is similar to the resolution of the digital converter 14. If the number of the tap number of the current equalizers 21 and 22 is larger than the minimum tap number requirement, step S1212 may be entered to reduce the tap number of the equalizer 21 and 22 by one. Since the signal energy is concentrated around the main cursor, the tap number of the equalizer 21, 22 is reduced from the tap number of the post-cursor farthest from the main cursor until the numbers of remaining pre-cursor and post-cursor are the same, and then it takes turns forward and backward to decrease towards the main cursor. For example, if the current equalizers 21 and 22 use the tap number of four, two of them are feed-forward equalizers 21 for eliminating the pre-cursor 1 and pre-cursor 2, and the other two of them are decision-feedback equalizers 22 for eliminating post-cursor 1 and post-cursor 2. When the signal to noise ratio is sufficient, the tap number of the feed-forward equalizer 21 for eliminating the pre-cursor 2 is subtracted first. If the signal to noise ratio is still sufficient, the tap number of the decision feedback equalizer 22 for eliminating the post-cursor 2 is subtracted. In this way, it takes turns to reduce the tap number towards the main cursor. If the value of the tap number of the current equalizers 21 and 22 has reached the minimum tap number requirement, no action will be taken.

In the same embodiment, the situation where the signal to noise ratio is insufficient is discussed. At this moment, the process first enters step S1213 to determine whether the tap number of the equalizers 21 and 22 can be increased, and then enters step S1214 to determine whether the resolution of the analog-to-digital converter 14 can be adjusted. If the tap number of the equalizers 21 and 22 has not reached the maximum value of the tap number in step S1215, the tap number of the equalizers 21 and 22 is increased in the reverse sequence of decrease, and the minimum requirement of the tap number is updated to the currently enabled number. If the tap number of the current equalizers 21 and 22 has reached the maximum number, step S1216 is entered to increase the resolution of the analog-to-digital converter 14. Similarly, in step S1221, the minimum resolution is updated to the current resolution and, at this moment, the minimum requirement of the tap number of the equalizers 21 and 22 is reset to zero, so that the system may try to reduce the tap number of the equalizers 21 and 22 again when increasing the resolution of the analog-to-digital converter 14. Eventually, the system will be stable with a sufficient signal to noise ratio and use the minimum resolution of the analog-to-digital converter 14 and the minimum tap number of the equalizers 21 and 22 to save power consumption. The method of the present disclosure may be extended to a circuit architecture using only the feed-forward equalizer 21 of any tap number, and may also be extended to a circuit architecture using any form of digital equalizers 21 and 22 of any tap number.

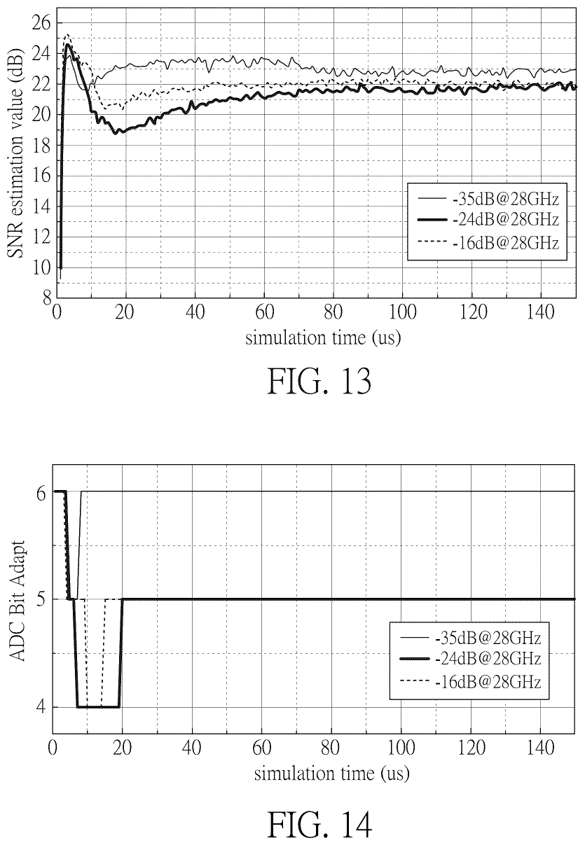

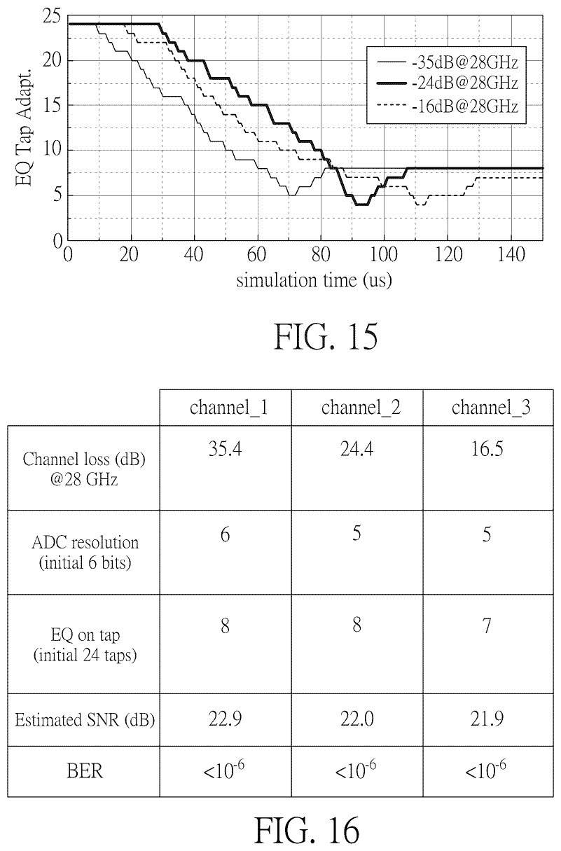

Finally, the simulation result is described. This simulation uses a 112 Gb/s PAM-4 transceiver and selects three channels with channel losses of 34.5 dB, 24.4 dB and 16.5 dB at 28 GHz to simulate the conditions of long channel, medium channel and short channel. FIG. 13 is a transient diagram of the ninth digital signal D_{SNR}[n] changing with time, wherein the estimated signal to noise ratio of any channel at about 10 us is higher than the minimum signal to noise ratio requirement, so that the process will enter the flow chart of FIG. 12 to begin resource adjustment. FIG. 14 and FIG. 15 respectively show the changes in the resolution of the analog-to-digital converter 14 and the tap number of the equalizers 21 and 22 over time, and finally the system is stabilized in the resource optimization state. That is, FIG. 14 may be regarded as an adaptive modulation of the resolution of the analog-to-digital converter 14, and FIG. 15 may be regarded as the adaptive modulation of the tap number of the equalizers. FIG. 16 shows the simulation results of dynamic allocation of receiver hardware resources for three different channel losses using the technology of the present disclosure.

The present disclosure successfully makes use of the signal to noise ratio estimation unit 26 to estimate the receiver signal to noise ratio information, and then uses the resource allocation control unit 27 to control the appropriate resolution of the analog-to-digital converter 14 and tap number of the equalizers 21,22 in different channel environments, so as to maintain the resulting bit error rate within a range defined by the specification and, at the same time, reduce the power consumption of the receiver system.

It should be noted that the above experimental examples are only examples but not limitations of the present disclosure, and the experimental values may vary due to different experimental environments.

In one embodiment of the present disclosure, an evidence may be provided by at least performing a comparison on a product through mechanism observation, such as the presence or absence of components or the operational relationship between components, so as to determine whether the product falls within the patent protection scope of the present disclosure, but not limited thereto. In one embodiment, the mechanism observation may be achieved, for example, by using the human eyes or equipment such as an optical microscope or a scanning microscope, but not limited thereto.

As a result, with the present disclosure, it is able to simplify the design of a high speed transceiver and coordinate the operations between equalizers to improve stability and reduce system power consumption. In addition, the high speed transceiver of the present disclosure has the functions of instantaneously and continuously adjusting the continuous time linear equalizer and being operated in the background.

In addition, the features of the various embodiments of the present disclosure may be mixed and matched as long as they do not violate the spirit of the invention or conflict with each other.

The aforementioned specific embodiments should be construed as merely illustrative, and not limiting the rest of the present disclosure in any way.

1. A high speed transceiver for receiving a transmitting end signal, comprising:
an analog front-end circuit set, including a digital-to-analog converter, wherein the transmitting end signal passes through the analog front-end circuit set to form a first digital signal;
a feed-forward equalizer electrically connected to the analog front-end circuit set;
a decision feedback equalizer electrically connected to the feed-forward equalizer, wherein the first digital signal passes through the feed-forward equalizer and the decision feedback equalizer to form a second digital signal;
a channel measurement circuit electrically connected to the front-end circuit set and the decision feedback equalizer, and configured to obtain channel feature information of a signal transmission channel based on the first digital signal and the second digital signal;
a signal to noise ratio estimation unit electrically connected to the decision feedback equalizer, and configured to obtain a signal to noise ratio of the transmitting end signal at a receiving end based on a third digital signal; and
a resource allocation control unit electrically connected to the signal to noise ratio estimation unit, and configured to obtain signal to noise ratio information based on a ninth digital signal so as to adjust a resolution of the analog-to-digital converter and adjust a tap number of the feed-forward equalizer, or a tap number of the decision feedback equalizer, or a tap number of the feed-forward equalizer and the decision feedback equalizer.

2. The high speed transceiver as claimed in claim 1, wherein the channel measurement circuit is implemented through an adaptive filter, and the channel measurement circuit is used to perform an adaptive operation on the second digital signal so that the second digital signal approaches the first digital signal.

3. The high speed transceiver as claimed in claim 1, wherein, when the adaptive operation of the channel measurement circuit reaches adaptation, a adaptation coefficient of the channel measurement circuit is used as the channel feature information.

4. The high speed transceiver as claimed in claim 3, wherein the channel measurement circuit uses a least-mean-square error algorithm to perform the adaptive operation.

5. The high speed transceiver as claimed in claim 3, wherein the feed-forward equalizer or the decision feedback equalizer supports a floating tap, and the channel measurement circuit includes a cursor selector, in which the cursor selector scans a plurality of equalizer coefficients of the feed-forward equalizer on a plurality of floating tap nodes and selects therefrom at least one floating tap node with a relatively large equalizer coefficient for use as a timing position of a floating cursor.

6. The high speed transceiver as claimed in claim 4, wherein the cursor selector uses the equalizer coefficient corresponding to the floating tap node as a coefficient of the floating cursor.

7. The high speed transceiver as claimed in claim 2, further comprising a signal to inter-symbol interference residual ratio calculation unit, and the signal to inter-symbol interference residual ratio calculation unit is based on the a sum of squares of the channel feature information of the channel measurement circuit to obtain inter-symbol interference feature information of the analog front-end circuit set.

8. The high speed transceiver as claimed in claim 7, further comprising a signal to inter-symbol interference residual ratio calculation unit and an inter-symbol interference control unit, wherein the inter-symbol interference residual ratio calculation unit obtains the inter-symbol interference residual feature information based on the sum of squares of the channel feature information of the channel measurement circuit, and the inter-symbol interference control unit uses the inter-symbol interference residual feature information to perform adaptive adjustment on a continuous time linear equalizer or a transmitting end equalizer.

9. The high speed transceiver as claimed in claim 8, wherein the inter-symbol interference control unit uses a gradient descent method to perform adaptive adjustment on the continuous time linear equalizer so as to find setting parameters of the continuous time linear equalizer when the signal transmission channel has highest signal to noise ratio.

10. The high speed transceiver as claimed in claim 1, wherein the signal to noise ratio estimation unit obtains a fifth digital signal, a sixth digital signal and an eighth digital signal through a level adaption unit and a Gaussian standard deviation adaptation unit, and calculates the signal to noise ratio through the fifth digital signal, the sixth digital signal and the eighth digital signal.

11. The high speed transceiver as claimed in claim 10, wherein the Gaussian standard deviation adaptation unit uses an offset distance of the third digital signal and the fifth digital signal to find a seventh digital signal adapted therefrom a Gaussian noise standard deviation, which is the eighth digital signal.

12. The high speed transceiver as claimed in claim 11, wherein a signal power is obtained by calculating a square of a difference between the fifth digital signal and the sixth digital signal, a noise power is obtained by calculating a square of the eighth digital signal, and the ninth digital signal is obtained by dividing the signal power and the noise power, where the ninth digital signal is an estimated signal to noise ratio.

13. The high speed transceiver as claimed in claim 11, wherein whether the Gaussian standard deviation calculation unit adapts or not is based on using a tolerance range to determine whether a adaptation value of a Gaussian noise standard deviation, which is the eighth digit signal, is maintained within an error range, and a difference of the Gaussian noise standard deviation is maintained within an error tolerance range under a given number of observations.

14. The high speed transceiver as claimed in claim 1, wherein the resource allocation control unit obtains a minimum threshold of signal to noise ratio through a relationship between a receiver bit error rate and the signal to noise ratio, and uses the minimum threshold of signal to noise ratio to adjust the resolution of the analog-to-digital converter and the tap number of the feed-forward equalizer and the decision feedback equalizer.

15. The high speed transceiver as claimed in claim 14, wherein the resource allocation control unit gives priority to adjustment of the resolution of the analog-to-digital converter when the signal to noise ratio is sufficient so as to optimize power consumption.

16. A background-type digital signal processing unit a high speed transceiver, wherein the high speed transceiver is used to receive a transmitting end signal and includes an analog front-end circuit set, and the transmitting end signal passes through the analog front-end circuit set to form a first digital signal, wherein the digital signal processing unit comprises:
a feed-forward equalizer electrically connected to the analog front-end circuit set;
a decision feedback equalizer electrically connected to the feed-forward equalizer, wherein the first digital signal passes through the feed-forward equalizer and the decision feedback equalizer to form a second digital signal;
a channel measurement circuit electrically connected to the front-end circuit set and the decision feedback equalizer, and is configured to obtain overall channel feature information of a signal transmission channel and the analog front-end circuit set based on the first digital signal and the second digital signal;
a signal to noise ratio estimation unit electrically connected to the decision feedback equalizer, and configured to obtain the signal to noise ratio at a receiving end based on a third digital signal; and
a resource allocation control unit electrically connected to the signal to noise ratio estimation unit, and configured to obtain signal to noise ratio information based on a ninth digital signal so as to adjust a resolution of an analog-to-digital converter and a tap number of the feed-forward equalizer and the decision feedback equalizer thereby performing adaptive adaptation on the high speed transceiver.
